(19) United States
(12) Patent Application Publication
(10) Pub. No.: US 2005/0073729 A1
(43) Pub. Date: Apr. 7, 2005

(54) Process and system for evaluating an optical recording

(76) Inventors: Urs Schmid, Feuerthalen (CH); Huedi Rottermann, Berneck (CH); Daniel Goggel, Dorabira (AT)

Correspondence Address: HODGSON RUSS LLP, ONE M & T PLAZA, SUITE 2000, BUFFALO, NY, 14203-2391, US

(21) Appl. No.: 10/996,679

(22) Filed: Nov. 24, 2004

Related U.S. Application Data
(63) Continuation of application No. PCT/EP03/05807, filed on Jun. 3, 2003.

(30) Foreign Application Priority Data
Sep. 1, 2003 (DE) 103 40 604.2
Jun. 6, 2002 (DE) 10226274.8

(51) Int. Cl. H04N 1/46

(52) U.S. Cl. 358/517

(57) ABSTRACT

The invention relates to a method and a system for evaluating an optical recording that has been registered by an image sensor (30). The image sensor (30) comprises a plurality of photosensitive elements (32, 34, 36), each of which is provided for determining the brightness value of exactly one of the colors from a predetermined set of colors, in such a way that each element (32, 34, 36) provides information about its corresponding associated color. The invention is characterized in that one of the colors is selected and during the evaluation only information from elements associated with the color is taken into consideration. In addition, the invention relates to use of the system and to a computer program product for carrying out the method.

### CROSS-REFERENCE TO RELATED APPLICATIONS

The present application claims benefit under 35 U.S.C. §§ 120 and 365(c) as a continuation of International Application No. PCT/EP03/05807 filed Jun. 3, 2003 designating the United States. The present application further claims benefit under 35 U.S.C. §§ 119 of German patent application no. 10226274.8 filed Jun. 6, 2002, priority of which is claimed in the aforementioned International Application No. PCT/EP03/05807.

### FIELD OF THE INVENTION

The invention relates to a process and a system for evaluating an optical recording taken by means of an image sensor. The image sensor comprises a plurality of photosensitive elements, each of which is intended to determine a brightness value of precisely one color from a given set or group of colors. Thus, each element acquires information relating to the associated color. The invention also relates to a use of the above-mentioned system and a computer program and a computer program product.

### BACKGROUND OF THE INVENTION

Known charge-coupled image sensors, so-called CCD image sensors (CCD=charge-coupled device), having originated from the field of video technology, have retained much of this technology. In order to be able to produce colored images the individual elements of an image sensor are usually provided with colored microfilters so that each element only detects light of a specific wavelength range representing a color and thus only supplies information regarding the brightness value of this color, i.e. emits a corresponding electrical signal.

Usually, elements are provided for the three basic colors, red, green and blue, which are usually arranged in a so-called Bayer mosaic. A noticeable feature of this is that for every red and blue filter there are two green filters. Consequently, typical sensors detect 50% green light, 25% blue light and 25% red light.

As the electronics of the camera receive only the exact brightness value for precisely one color for each image dot or each pixel, the other two colors have to be calculated from the values of the adjacent pixels by interpolation.

U.S. Pat. No. 6,181,376 B1, for example, discloses a method of determining the missing tristimulus values for pixels in a color filter array. In the process described, the known color values are interpolated along diagonal lines.

EP Patent 0 720 387 A2 describes a process and an apparatus for generating interlace images from a sensor with progressive scanning in an electronic camera. The clock rate required is reduced, while the interlace pixel values for all the colors are provided in the same range.

Many image sensors operate in so-called full-image mode and can only be read off in full. A problem of this is that with a large image sensor this can take a relatively long time, so that it is not possible to display a fluid live image for focusing or for determining the field of view by object positioning or for adjustment of the magnification.

Other image sensors operate by the conventional half-image method of video technology. In this process, the even or odd lines (rows) of the sensor are illuminated and read off alternately. The fields are then electronically assembled to make complete images. A disadvantage of this is that this process is carried out sequentially and therefore complicated meshing algorithms are needed in order to display the complete color image correctly.

### SUMMARY OF THE INVENTION

The objective of the present invention is therefore to propose a process and a system which make it possible to evaluate an optical recording detected by an image sensor quickly and easily in order to be able to carry out focusing or object positioning or adjustment of the magnification thereof, for example, within the scope of this evaluation.

To achieve this end, the process according to the invention for evaluating an optical recording taken by an image sensor, wherein the image sensor comprises a plurality of photosensitive elements and each of the elements is intended to determine a brightness value of precisely one color from a given set of colors, so that each element acquires information relating to the associated color, in said process one of the colors is selected from the given set of colors and during evaluation only information from the elements provided for this color is taken into consideration.

Thus, only one color extract, expediently the one with the most information, is read off and the rest are discarded. Although this reduces the resolution accordingly, the reduction of resolution is hardly noticeable with a high resolution sensor. The time saving achieved by the process during the reading off of the sensor or during the evaluation of the information obtained, on the other hand, is considerable. In addition, the reduction in the number of pixels is desirable for many applications. As there is no interpolation, it is also possible to produce images with less noise.

Preferably, the elements of the image sensor are arranged in a matrix of lines (rows) and columns. In this case it is possible for only even or odd lines of the image sensor to be read off selectively. In the half-image thus produced, only the information from the elements provided for the selected color is then used for the evaluation.

In this embodiment of the process according to the invention only the desired half image is read out and only the required color information is read out from it. There is no need for time-consuming color interpolation. Consequently, there is no need to settle for the reduced resolution caused by interpolation either. The resulting images are obtained in the selected color, allowing the image information to be displayed more rapidly and with less noise.

In the so-called half image process, it is not right hand or left hand half images but odd or even lines which are loaded into a shift register.

Usually the elements are provided for the three basic colors red, green and blue, the elements preferably being arranged in a Bayer mosaic.

According to the invention the elements are provided with color microfilters. These ensure that only light of a specific wavelength range can be transmitted and hence absorbed by the relevant element, so that each element only supplies information as to the brightness or intensity of the light of one wavelength range and hence relating to a particular color, i.e. is intended for this color.

The information from the elements provided for the selected color is usually displayed as an image on a display unit.

The process according to the invention allows fast focusing, object positioning and adjustment of the magnification.

The system according to the invention for evaluating an optical recording comprises an image sensor for registering the optical recording and a computer unit for processing information received by means of the image sensor. The image sensor comprises a plurality of photosensitive elements, each one of which is intended to determine a brightness value of precisely one color from a given set of colors. The system is characterized in that the computer unit is programmed to select one of the colors, preferably the one with the greatest information content associated with it, and is also programmed to take into consideration, during the evaluation, only information from the elements provided for the selected color.

The elements of the image sensor are preferably arranged in a matrix of lines and columns.

In one embodiment the computer unit is programmed so as to read out only even or odd lines of the image sensor, as selected. This selection is preferably also done by the computing unit.

Other features of the system according to the invention will become apparent from the subsidiary claims.

The system is particularly suitable for evaluating monochrome images such as, for example, images in microscopy, particularly fluorescence microscopy. In microscopy there is frequently only a monochrome image, e.g. in the fluorescent examination of an object. In conventional processes, color information is recorded with four pixels. Then for each pixel the color is calculated by interpolation with the surrounding pixel colors. This is time-consuming. In a single-color image the other pixels have no brightness information and therefore produce only noise, which can falsify the image. This was not taken into consideration in conventional read-out and evaluating processes.

By the use of the process according to the invention the image rate in the focusing of monochrome images, as are frequently used in fluorescence microscopy, can be virtually doubled compared with a conventional process as one of the two half images is not used at all. By dispensing with color interpolation the displaying of the color extract can also be speeded up compared with known methods.

The color pixels which do not belong to the selected color extract are omitted and therefore the noise information contained therein cannot interfere with the color extract. The result is a low-noise rapid grey scale image for optimum focusing and determining of the field of view.

The new process can be used for assisting special so-called read-out modes in the operation of a CCD image sensor or a digital camera. The process is particularly recommended for high resolution image sensors as in these sensors the reduction in resolution caused by the process is of no relevance. In live image displays, a reduction in the number of pixels is often even desirable in order to be able to determine the desired field of view comfortably.

The computer program according to the invention comprises program coding means for performing all the steps of a process as described above. It is run on a computer or corresponding computing unit.

The computer program product according to the invention is stored on a computer-readable medium. Suitable computer-readable media include, without limitation, EEPROMS and flash memories as well as CD-ROMS, discs and disc drives.

Further advantages and embodiments of the invention will become apparent from the description and accompanying drawings.

It will be appreciated that the features mentioned above and those to be described hereinafter may be used not only in the particular combination specified but also in other combinations or on their own without departing from the scope of the present invention.

### BRIEF DESCRIPTION OF THE DRAWING FIGS.

The invention is illustrated by means of exemplifying embodiments in the drawings and is described in detail hereinafter with reference to the drawings.

FIG. 1 illustrates the known half-image process;

FIG. 2 diagrammatically shows an embodiment of the process according to the invention;

FIG. 3 diagrammatically shows another embodiment of the process according to the invention;

FIG. 4 diagrammatically shows another embodiment of the process according to the invention; and

FIG. 5 diagrammatically shows a possible use of the process according to the invention.

### DETAILED DESCRIPTION OF THE INVENTION

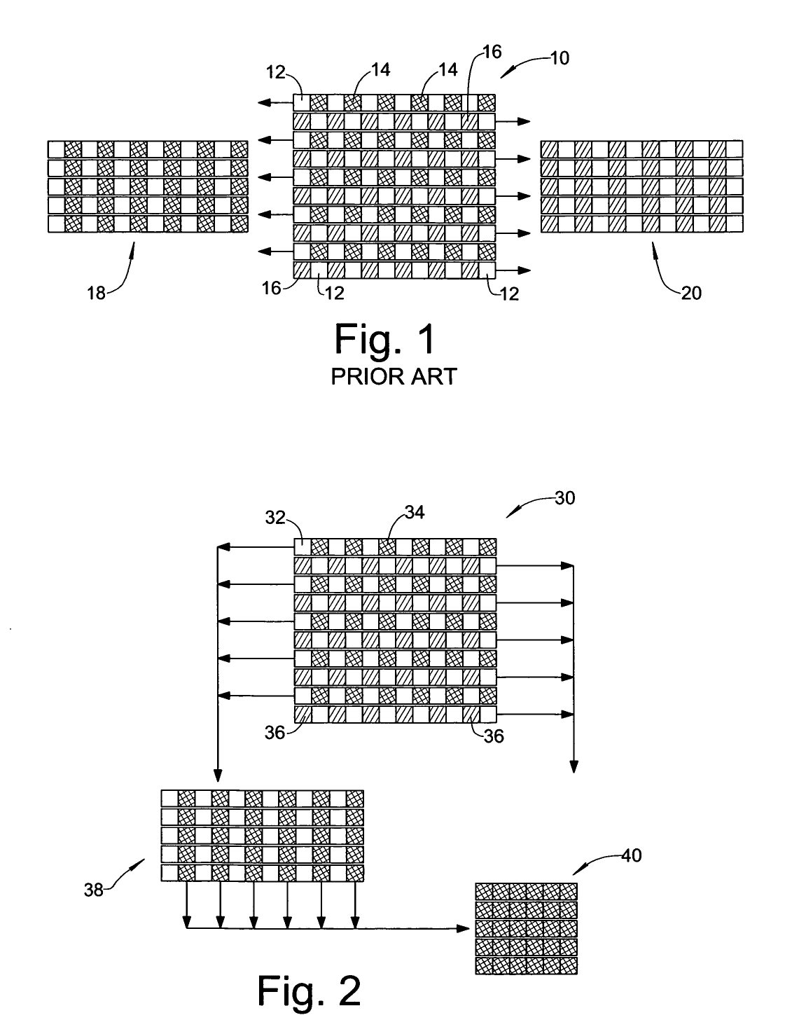

FIG. 1 diagrammatically shows the conventional half image process as an illustration. It shows an image sensor 10 which comprises a plurality of photosensitive elements arranged in a matrix of lines and columns, with elements 12 being provided for the color green, elements 14 for the color red and elements 16 for the color blue. The elements 12 are thus provided with a green color microfilter, the elements 14 with a red color microfilter and the elements 16 with a blue color microfilter.

It will be seen that the elements 12, 14 and 16 for the three basis colors red, green and blue are arranged in a so-called Bayer mosaic. There are two green filters for each red and blue filter.

For the first, third, fifth, seventh and ninth lines, i.e. for the odd lines of the image sensor 10, a first half image 18 is produced and for the second, fourth, sixth, eight and tenth lines, i.e. for the even lines of the image sensor 10, a second half image 20 is produced. The two half images 18 and 20 are produced by first illuminating and then reading out the corresponding lines.

In the half image process the even or odd lines of the image sensor 10 are read out alternately. The half images 18 and 20 are then typically assembled electronically.

FIGS. 2 to 4 illustrate the process according to the invention in more detail. Again, an image sensor 30 is provided having a plurality of elements 32, 34 and 36 arranged in a matrix, the elements 32 being provided for the color green, the elements 34 for the color red and the elements 36 for the color blue.

As can be seen in FIG. 2, first of all a first half image 38 is produced, i.e. only the odd lines of the image sensor 30 are read out. This half image 38 shows only green and red pixels. Then only the elements 34 for the color red are taken into consideration and the results are shown in an image 40, which shows a red color extract. The elements 32 and the information they acquire are not taken into consideration in the rest of the evaluation.

The pixel number of the image 40 is less than the pixel number of the sensor 30 by a factor 4. However, as no interpolation is needed, the image 40 can be obtained quickly. Then focusing or evaluation of the field of view can be carried out with this low noise image 40.

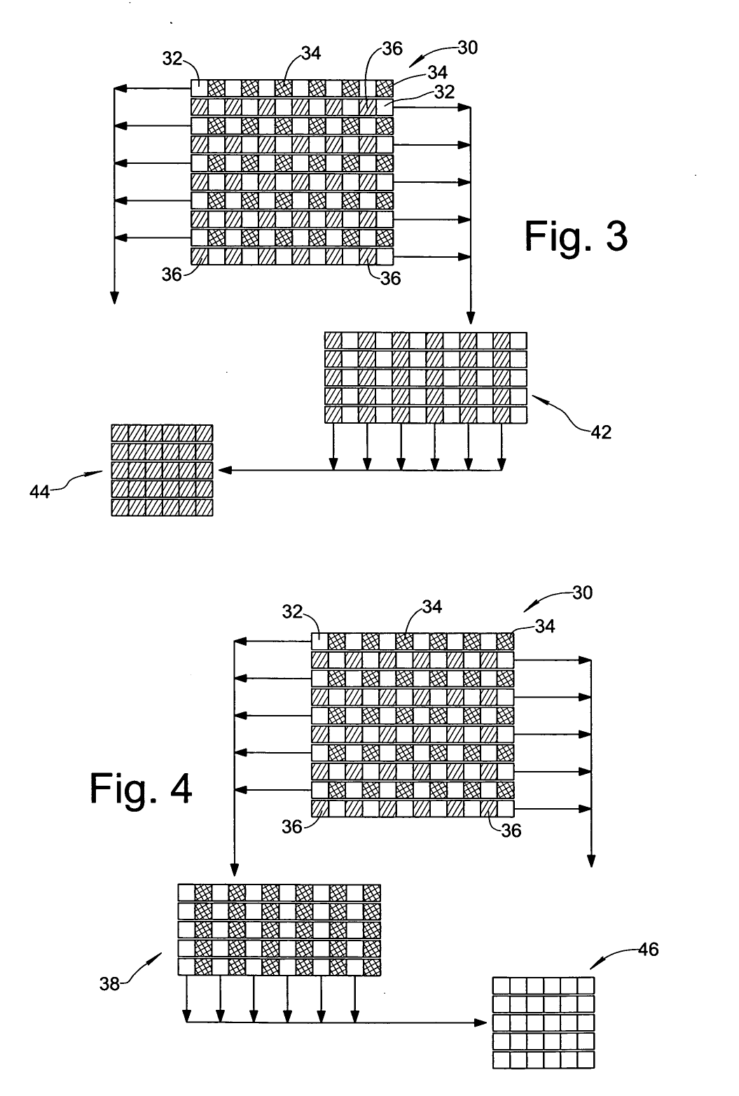

FIG. 3 accordingly shows a second half image 42 obtained by reading out the even lines of the image sensor 30. From this half image 42, another image 44 is obtained, showing a blue color extract, in which only the elements 36 for the color blue are taken into consideration.

FIG. 4 shows the half image 38 from FIG. 2. In this case, an image 46 is produced from the half image 38, showing a green color extract.

The green color extract can be obtained from the first half image 38 or the second half image 42.

In the process according to the invention the displaying of the color extract can be speeded up, compared with conventional processes, by doing away with color interpolation. The color pixels which do not belong to the selected color extract are omitted and the noise information they contain therefore cannot interfere with the color extract.

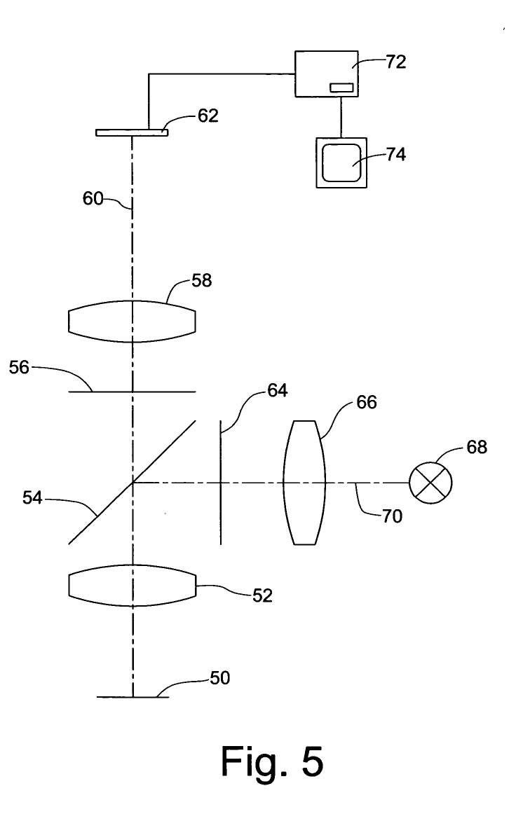

FIG. 5 shows a possible use of the process according to the invention, shown diagrammatically. The figure shows an object 50 which is to be imaged, an objective 52, a dichroic beam splitter 54, a blocking filter 56, a tube lens 58, a microscope axis 60, a sensor 62 at an image plane, an excitation filter 64, a collector lens 66, a light source 68 and an illumination axis 70. A computer unit 72 is connected to the sensor 62 and to a display unit 74.

In the figure shown, a fluorescent object 50 is located in the focal plane of the objective 52 and is imaged on the sensor 62 by the objective 52 and by the tube lens 58. Between the objective 52 and the tube lens 58 a zone is formed with a so-called parallel beam path. Additional elements can optionally be moved into this zone. In fluorescence microscopy these are usually the beam splitter 54 shown in FIG. 5, for connecting up the illumination means, and the blocking filter 56.

The blocking filter 56 lets through only light with the wavelength of the fluorescent beam emitted by the object 50. The short-wave light for fluorescent excitation is not allowed through by the blocking filter 56 and consequently cannot contribute to the image production.

In order to illuminate the object 50 the light from the light source 68 is focused by the collector lens 66 and reflected by the beam splitter 54 in the direction of the object 50. The excitation filter 64 lets through only light of the wavelength which serves to excite fluorescence. Illuminating light from the light source 68 of the longer-wave fluorescent radiation is blocked by the excitation filter 64 and therefore cannot overlay the fluorescent radiation and impair its visibility.

In order to increase the light efficiency it is useful to construct the beam splitter 54 as a dichroic beam splitter 54 as this reflects the short-wave excitation light to a high degree and has a high transmittance for the long-wave fluorescent radiation.

Using the setup shown in FIG. 5 a monochrome image is produced which can be evaluated using the process according to the invention. For this purpose a computer unit 72 is connected to the sensor 62 and is programmed to select one color, e.g. the green color, from a given set of colors, e.g. the colors green, red and blue in the above embodiment. During evaluation of the image, only information from the elements of the sensor 62 provided for the selected color (green in this example) are taken into account. The processed image data are then displayed on the display unit 74.

1. A process for evaluating a recording acquired using an image sensor, wherein the image sensor comprises a plurality of photosensitive elements and each of the elements provides information indicative of a brightness value of precisely one color from a given set of colors, so that each element provides information on the one color associated with that element, the process comprising the steps of:
selecting one of the colors from the given set of colors;
taking into consideration, during evaluation of the recording, only information from elements with which the selected color is associated.

2. The process according to claim 1, wherein the elements of the image sensor are arranged in a matrix of lines and columns.

3. The process according to claim 2, wherein the step of taking into consideration only information from elements with which the selected color is associated includes the steps of:
reading out information from only even or only odd lines of the image sensor to produce a half image; and
reading out only information from the half image corresponding to the selected color.

4. The process according to claim 1, wherein the given set of colors consists of the colors red, green and blue.

5. The process according to claim 4, wherein the elements for the colors red, green and blue are arranged in a Bayer mosaic.

6. The process according to claim 1, wherein each of the elements includes a color microfilter.

7. The process according to claim 1, further comprising the step of displaying the information taken into consideration.

8. The process according to claim 1, further comprising the step of focusing an object image on the image sensor using the information taken into consideration.

9. The process according to claim 1, further comprising the step of positioning an object image with respect to the image sensor using the information taken into consideration.

10. The process according to claim 1, further comprising the step of adjusting magnification of an object image using the information taken into consideration.

11. A system for evaluating a recording of an image, the system comprising:
an image sensor arranged to receive the image, the image sensor including a plurality of photosensitive elements, each of the elements providing information indicative of a brightness value of precisely one color from a given set of colors;
a computer unit connected to the image sensor, the computer unit being programmed to select one of the colors from the given set of colors and to take into consideration, during evaluation of the recording, only information from elements with which the selected color is associated.

12. The system according to claim 11, wherein the elements of the image sensor are arranged in a matrix of lines and columns.

13. The system according to claim 12, wherein the computer unit is programmed to read out information from only even lines or from only odd lines of the image sensor.

14. The system according to claim 11, wherein the given set of colors consists of the colors red, green and blue.

15. The system according to claim 14, wherein the elements for the colors red, green and blue are arranged in a Bayer mosaic.

16. The system according to claim 11, wherein each of the elements includes a color microfilter.

17. The system according to claim 11, further comprising a display unit connected to the computer unit for displaying the information taken into consideration.

18. A process of evaluating images acquired by fluorescence microscopy comprising the step of utilizing the system of claim 11.

19. A process of positioning an object image with respect to an image sensor comprising the step of utilizing the system of claim 11.

20. A process of adjusting magnification of an object image comprising the step of utilizing the system of claim 11.

21. A computer-readable medium having computer-executable instructions for performing the steps of:
reading information from an image sensor receiving an image, wherein the image sensor includes a plurality of photosensitive elements, each of the elements providing information indicative of a brightness value of precisely one color from a given set of colors;
selecting one of the colors from the given set of colors;
obtaining a color extract image by taking into consideration only information from elements with which the selected color is associated.

22. The computer-readable medium according to claim 21, wherein the elements of the image sensor are arranged in a matrix of lines and columns, and the computer-readable medium has computer-executable instructions for obtaining the color extract image by performing the steps of:
extracting a half-image by reading out information from only even or only odd lines of the image sensor; and
reading out only information from the half image corresponding to the selected color to obtain the color extract image.

23. The computer-readable medium according to claim 21, wherein the given set of colors consists of the colors red, green and blue.

24. The system according to claim 23, wherein the elements for the colors red, green and blue are arranged in a Bayer mosaic.
